(19) United States
(12) Patent Application Publication
(10) Pub. No.: US 2002/0028679 A1
(43) Pub. Date: Mar. 7, 2002

(54) Data transmission based on available wireless bandwidth

(76) Inventors: Eric Edwards, San Francisco, CA (US); Clay Harvey Fisher, Belmont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/850,854

(22) Filed: May 7, 2001

Related U.S. Application Data
(60) Provisional application No. 60/230,876, filed on Sep. 7, 2000.

(51) Int. Cl. H04Q 7/20

(52) U.S. Cl. 455/452; 455/453; 455/450; 455/512

(57) ABSTRACT

Data is selectively transmitted over a wireless communications network based on availability of bandwidth in the network. A wireless device that will transmit the data receives notification of bandwidth availability, either periodically or in response to a specific request for an amount of bandwidth.

### RELATED APPLICATIONS

This application claims the benefit of U.S. Provisional Application Serial No. 60/230,876 filed on Sep. 7, 2000.

### FIELD OF THE INVENTION

This invention relates generally to wireless communications networks, and more particularly to the transmission of data through such wireless communication networks.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2000, Sony Electronics, Inc., All Rights Reserved.

### BACKGROUND OF THE INVENTION

Current wireless communication networks were designed to support voice transmission, such as wireless telephones, and limited data transmission, such as pagers. Such transmissions tend to be of relatively short duration and “bursty.” Now, however, those wireless communication networks are being used to transmit continuous streams of data that is many times greater in bandwidth than the networks were originally designed to handle, causing network congestion and potentially failure of the network infrastructure due to overloading conditions.

### SUMMARY OF THE INVENTION

Data is selectively transmitted over a wireless communications network based on availability of bandwidth in the network. The amount of bandwidth necessary to transmit the data is determined and the data is transmitted when the amount of bandwidth is available. In one aspect, a wireless device that will transmit the data sends a request to the wireless communications network for notification when the amount of bandwidth becomes available. In another aspect, the wireless communications network periodically sends notification of available bandwidth and the wireless device determines if the available bandwidth is sufficient to transmit the data.

Selectively transmitting data over wireless communications networks when there is sufficient bandwidth to handle the data eases the congestion on networks not designed for such traffic and helps prevent failures in the network infrastructure by reducing the burden on the infrastructure components. Additionally, the selective transmission of data may shift data transmission into periods in which the network is less heavily loaded to utilize surplus bandwidth that would otherwise be unused.

The present invention describes systems, wireless devices, computers, methods, and machine-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1A is a diagram illustrating a overview of the operation of an embodiment of a wireless communications system according to the invention;

FIG. 1B is a diagram of a wireless communications environment suitable for practicing the invention;

FIG. 1C is a diagram of a wireless device suitable for practicing the invention;

FIG. 1D is a diagram of a computer suitable for practicing the invention;

FIG. 2A is a flow diagram of a method to be performed by a wireless device according to an embodiment of the invention;

FIGS. 2B and 2C are flow diagrams of supporting methods for the method of FIG. 2A; and

FIG. 3 is a flow diagram of a method to be performed by a computer managing a wireless communications network according to an embodiment of the invention.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense, and the scope of the present invention is defined only by the appended claims.

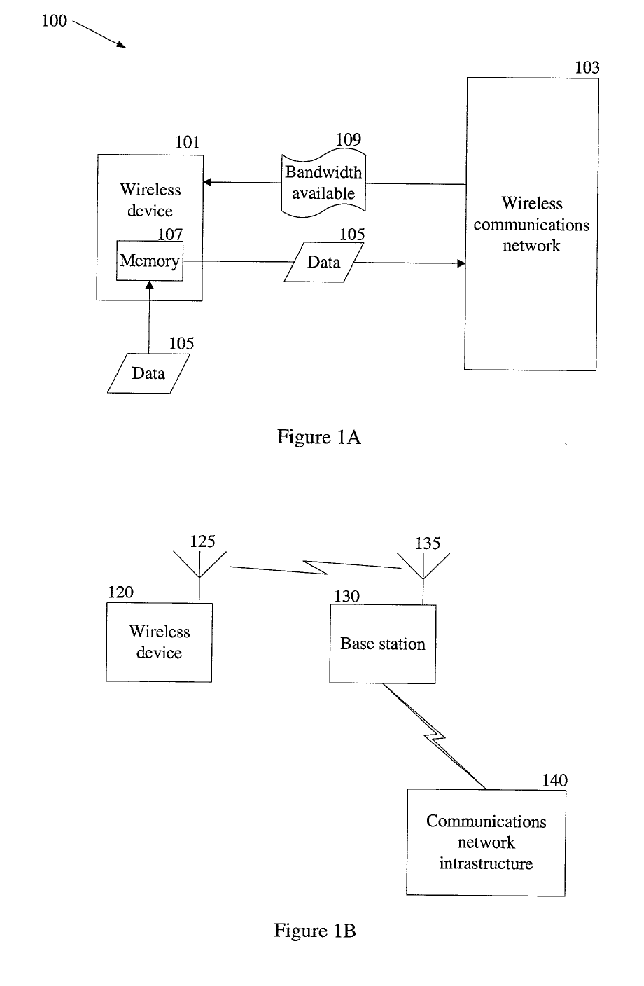

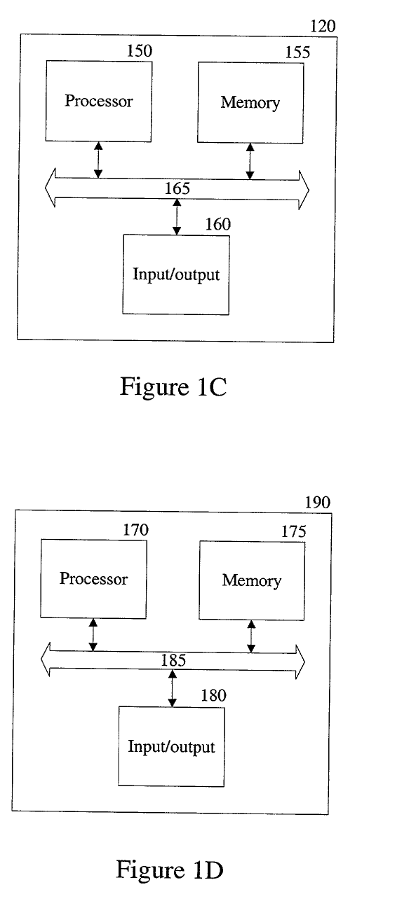

Beginning with an overview of the operation of the invention, FIG. 1A illustrates one embodiment of a wireless communications system 100 that transmits data 105 from a wireless device 101 to a wireless communications network 103 based on available bandwidth in the network 103. The wireless device 101 receives the data 105 through an input interface, such as a keypad, voice recognition, computer connection, or removable storage device. The data 105 may be immediately transmitted if sufficient bandwidth is available in the network 103, or stored in a memory 107 in the device 101 to await transmission when sufficient bandwidth becomes available. When the wireless device 101 receives a notice 109 that sufficient bandwidth is available, the wireless device 101 transmits the data 105 from the memory 107 to the wireless communication network 103. The notice 109 may be a general notification of available bandwidth sent periodically on a schedule or when network bandwidth conditions require. The notice 109 may be a specific notification sent in response to a request from the wireless device 101 to be specifically notified when sufficient bandwidth for its data becomes available. It will be appreciated that the network 103 may be coupled to other communication networks, wired or wireless, to further transmit the data 105 to other devices, wired or wireless.

In one embodiment of the wireless communications network 103, as shown in FIG. 1B, a wireless device 120, such as wireless device 101, transmits data through an antenna 125 to a corresponding antenna 135 at a base station 130 that couples the wireless device 120 to various components that form an infrastructure 140 for the wireless communications network 103. The connection between the base station 130 and the communication infrastructure 140 may be wireless, wired, or a combination. One of skill in the art will readily appreciate that multiple wireless devices 120 may be transmitting data to the base station 130 simultaneously, and that multiple base stations 130 may be transmitting data to the communications network infrastructure 140. Although not shown in FIG. 1B, it will be further appreciated that the infrastructure 140 may be coupled to other networks, wired or wireless, including but not limited to public wide area networks, such as the Internet, virtual private networks that use a public wide area network as a communications medium, and private local area networks.

One embodiment of the wireless device 120 suitable for use as wireless device 101 is illustrated in FIG. 1C. The wireless device 120 may be a pager, cellular telephone, a computer or personal digital assistant (PDA) equipped with wireless communications equipment, or the like. The wireless device 120 includes a processor or processing unit 150, memory 155, and an input/output interface 160 coupled to a bus 165. The memory 155 is configured to store instructions which, when executed by the processor 150, perform the methods described herein. The memory 155 may also store data that is awaiting transmission. Input/output interface 160 includes antenna 125 to transmit and receive data through the wireless communications network 130, and further provides for the input of the data to be transmitted to the network 103 and for the output of data received from the network 103. Input/output interface 160 also encompasses various types of machine-readable media, including any type of storage device that is accessible by the processor 150. In one embodiment, the input/output interface 160 includes a memory slot that accepts removable memory cartridges. One of skill in the art will immediately recognize that the term “machine-readable medium/media” further encompasses a carrier wave that encodes a data signal. It will also be appreciated that the wireless device 120 executes a wireless communication operating system that enables the data transmission to the base station 130. The memory 155 stores the executable instructions for the operating system and the methods of the present invention as well as data.

Although not shown in FIG. 1B, one of skill in the art will immediately understand that the communications network infrastructure 140 includes one or more computers that manage the wireless communications network 103. It will be appreciated that such a computer may be one of many possible computer systems which have different architectures. A typical computer system 190 will usually include at least a processor or processing unit 170, a memory 175, and an input/output interface 180 coupled to a system bus 185, as illustrated in FIG. 1D, in which the processor 170 executes instructions that perform the methods of the invention described herein and the input/output interface 180 couples the computer to one or more base stations 130 and to any further networks. One of skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications medium.

The preceding description of FIGS. 1B-D is intended to provide an overview of hardware and operating environments suitable for practicing the invention, but is not intended to limit the applicable environments. Furthermore, the invention is not limited to any particular arrangement of wireless devices and networks but for sake of clarity a simplified system of wireless devices, base stations, and network infrastructure components has been illustrated and described with reference to FIGS. 1A-D.

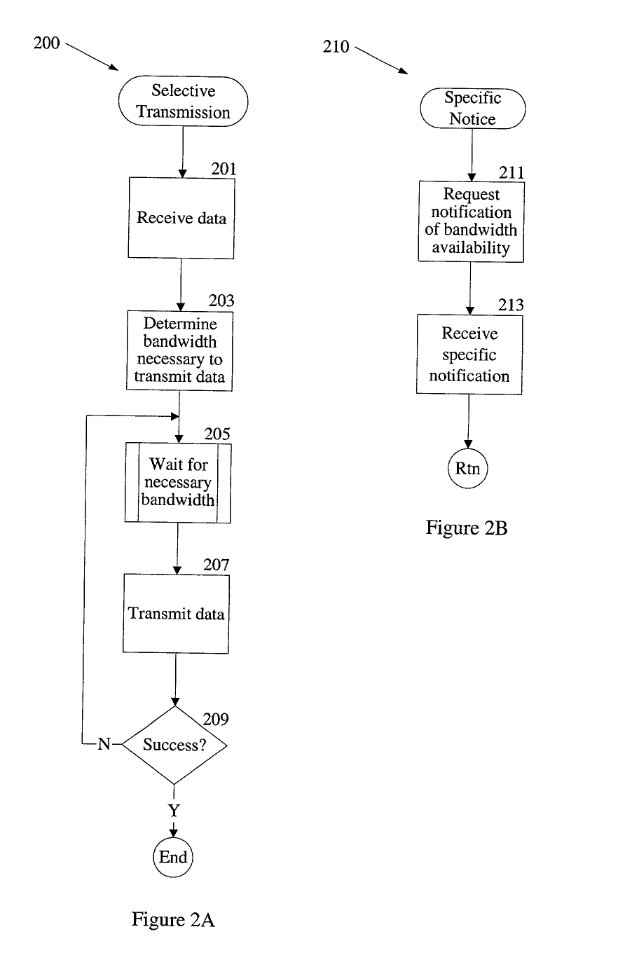

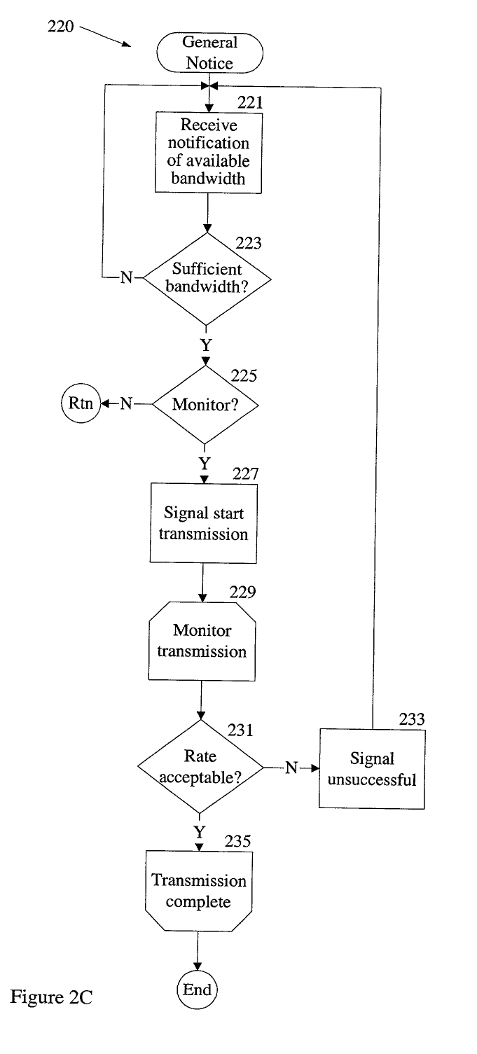

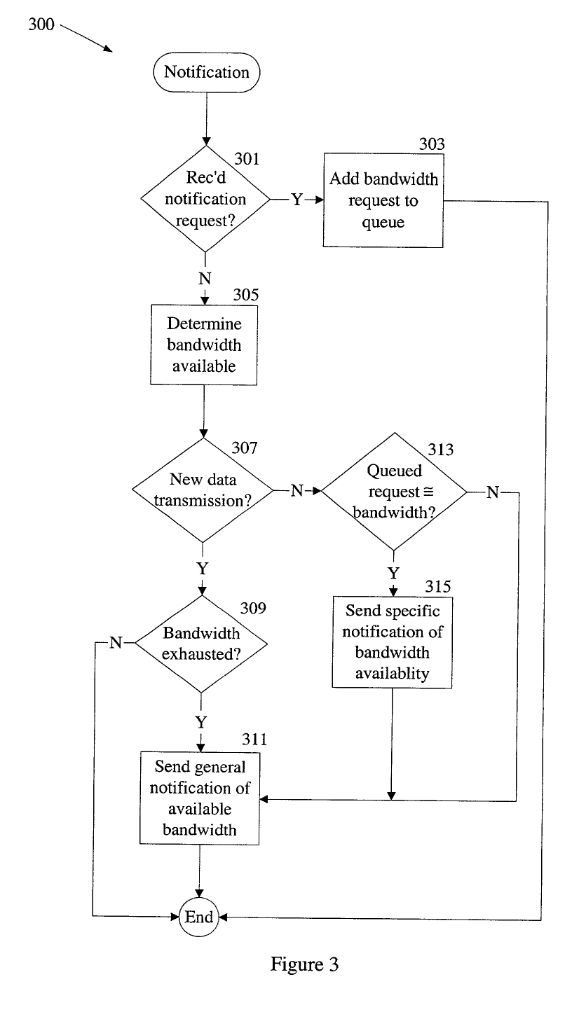

Next, the particular methods of the invention are described in terms of computer software with reference to a series of flow diagrams. FIGS. 2A-C illustrate one embodiment of a selective transmission method 200 and supporting methods 210, 220 for the wireless device 101. FIG. 3 illustrates one embodiment of a corresponding notification method 300 for an computer that manages the communications network 103. The methods constitute software programs made up of executable instructions illustrated as blocks (acts) 201 until 209, from 211 until 213, and from 221 until 235 in FIGS. 2A-C, and from 301 until 315 in FIG. 3. Describing the methods by reference to flow diagrams enables one skilled in the art to develop such software programs including such instructions to carry out the methods on suitably configured devices (the processor of the device executing the instructions from machine-readable media, including memory). The executable instructions may be written in a programming language or may be embodied in firmware logic. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a device causes the processor of the device to perform an action or a produce a result. It will be appreciated that more or fewer processes may be incorporated into the methods illustrated in FIGS. 2A-C and 3 without departing from the scope of the invention and that no particular order is implied by the arrangement of blocks shown and described herein.

Referring first to FIG. 2A, the acts to be performed by a wireless device executing the selective transmission method 200 are shown. Upon receipt of data to be transmitted over the wireless communications network (block 201), the method 200 determines the bandwidth necessary to transmit the data (block 203). The method 200 waits for the necessary bandwidth to become available (block 205).

In one embodiment, the wait processing at block 205 is performed by a specific notice method 210 as illustrated in FIG. 2B. The specific notice method 210 requests notification from the network when the required amount of bandwidth becomes available (block 211). Upon receipt of such notification (block 213), the method 210 returns to the selective transmission method 200.

In an alternate embodiment, the wait processing at block 205 is performed by a general notice method 220 as illustrated in FIG. 2C. The general notice method 220 receives general notifications of available bandwidth from the network (block 221) and determines if there is sufficient bandwidth to transmit the data (block 223). If there is insufficient bandwidth, the method 220 waits for the next general bandwidth notification from the network at block 221.

If there is sufficient bandwidth, the method 220 determines if it should monitor the transmission of the data (block 225). Monitoring may be desirable when a large amount of data is to be transmitted because multiple devices receiving the general notification may attempt to transmit at the same time and exhaust the available bandwidth. It will be appreciated that other criteria for monitoring the transmission may be incorporated into the processing represented by block 225. Alternate embodiments in which monitoring is never or always performed are also contemplated as within the scope of the invention. If the method 200 determines monitoring is not necessary, the method 220 returns to the selective transmission method 200 at block 207 to begin the data transmission. Otherwise, the method 220 signals the selective transmission 200 to begin the transmission (block 227) and begins a monitoring loop at block 229. At pre-defined intervals, the method 220 determines if the transmission rate of the data is acceptable based (block 231). If not, the method 220 signals the selective transmission method 200 that the transmission is unsuccessful (block 233) and proceeds to block 221 to wait for the next general notification from the network. If the transmission rate does not fall below acceptable levels, the method 220 terminates once the data is completely transmitted (block 235). The acceptable levels may be global for all data transmissions or specific to a particular data transmission.

Returning to FIG. 2, when the method 200 resumes at block 207, the necessary bandwidth is available and the method 200 transmits the data (block 207). If the transmission is unsuccessful (block 209), the method 200 waits at block 205 for another selective or periodic notification. Data transmission may be unsuccessful because the data transmission rate is unsatisfactory, such as determined by method 220, because of loss of wireless signal by the device, or because of other device and/or network problems.

It will be appreciated that if the wireless device has stored multiple data files for transmission, multiple instances of the methods 200, 210, and 220 will be operational concurrently and that the wireless device may request a specific notification for one data file through method 210 while relying on general notifications for another through method 220. The specific notifications received will be directed to the appropriate instance of method 210 based on a request number or other identifier that uniquely matches the notification with the corresponding request. When relying on the general notifications, additional processing may be performed at block 207 to coordinate among multiple data files that may fit within the available bandwidth, including sending more than one data file.

Turning now to FIG. 3, the corresponding notification method 300 that is executed by a computer managing the communications network is described. In the embodiment shown in FIG. 3, the notification method 300 is invoked in response to the occurrence of three types of events: a notification request from a device, the start of a new data transmission from a device, or a schedule event that controls the sending of general notifications. Alternate embodiments that respond to more or fewer events are also contemplated as within the scope of the invention. If a notification request is received (block 301), the method 300 queues the bandwidth request (block 303) for processing when the requested bandwidth becomes available. Because the other two events cause the method 300 to evaluate the bandwidth of the network, the method 300 determines the bandwidth available in the network (block 305). If a new data transmission is starting (block 307) and the method 300 determines the amount of data incoming will exhaust the available bandwidth (block 309), it sends general notification of zero available bandwidth to all devices (block 311) to prevent additional devices from attempting to send data. If the method 300 was invoked by receipt of a schedule event, the method 300 checks the request queue for a request for bandwidth that is substantially equal to the available bandwidth (block 313). If such a request is found, the method 300 sends a specific notification to the requesting device that the requested bandwidth is available (block 315) and also sends general notification of the remaining available bandwidth at block 311. If all queued requests are greater than the available bandwidth, the method 300 sends general notification of the available bandwidth at block 311.

It will be appreciated that various embodiments of the request queue and the selection of one or more requests from the queue may be incorporated into the method 300. For example, if the users of the wireless devices pay different service fees, the queue can be prioritized by fee amounts. Additionally, if no single request requires all the available bandwidth, the method 300 may send the specific notification at block 315 to multiple devices with requests that substantially total the amount of available bandwidth. Furthermore, checking the request queue against the available bandwidth at block 313 could be triggered by an event other than the schedule event and at different time periods than specified by the schedule so that the queue could be checked more or less frequently than the dictated by the schedule for general notification.

Selective data transmission based on bandwidth availability for wireless communication networks has been described. The selectively transmission of data eases the congestion on networks not designed for such traffic and helps prevent failures in the network infrastructure by reducing the burden on the infrastructure components. Additionally, the selective transmission of data may shift data transmission into periods in which the network is less heavily loaded to utilize surplus bandwidth that would otherwise be unused. Thus, in exchange for agreeing to the selective transmission of its data, the owner of the wireless communications network could discount the cost of such data transmission.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

What is claimed is:

1. A computerized method for selectively transmitting data in a wireless communications network comprising:
determining an amount of bandwidth necessary to transmit data in the wireless communications network; and
transmitting the data when the amount of bandwidth is available.

2. The computerized method of claim 1 further comprising:
sending a request for specific notification when the amount of bandwidth becomes available; and
receiving the specific notification that the amount of bandwidth is available.

3. The computerized method of claim 2 further comprising:
receiving the request; and
sending the specific notification when the amount of bandwidth becomes available.

4. The computerized method of claim 1 further comprising:
receiving general notification of available bandwidth; and
determining if the available bandwidth is sufficient to transmit the data.

5. The computerized method of claim 4 further comprising:
monitoring a transmission rate for the data; and
terminating transmission of the data if the transmission rate is unacceptable.

6. The computerized method of claim 4 further comprising:
sending the general notification of available bandwidth.

7. The computerized method of claim 6, wherein the general notification is sent on a pre-defined schedule.

8. The computerized method of claim 6, wherein the general notification is sent when a data transmission exhausts the available bandwidth.

9. The computerized method of claim 6, wherein the general notification is sent in conjunction with sending specific notification of a requested amount of bandwidth.

10. A computerized method for selectively transmitting data in a wireless communications network comprising:
receiving a request for specific notification when an amount of bandwidth becomes available in the wireless communications network; and
sending the specific notification when the amount of bandwidth becomes available.

11. The computerized method of claim 10 further comprising:
adding the request to a queue; and
searching the queue for a request for an amount of bandwidth that substantially matches the available bandwidth.

12. The computerized method of claim 11 further comprising:
sending general notification of available bandwidth if all requests in the queue are for amounts of bandwidth greater than the available bandwidth.

13. The computerized method of claim 12, wherein the general notification is sent on a pre-defined schedule.

14. The computerized method of claim 12, wherein the general notification is sent when a data transmission exhausts the available bandwidth.

15. The computerized method of claim 12, wherein the general notification is sent in conjunction with sending specific notification of a requested amount of bandwidth.

16. A machine-readable medium having executable instructions to cause a processor in a wireless device to perform a method comprising:
determining an amount of bandwidth necessary to transmit data in the wireless communications network; and
transmitting the data when the amount of bandwidth is available.

17. The machine-readable medium of claim 16, wherein the method further comprises:
sending a request for specific notification when the amount of bandwidth becomes available to the wireless communications network; and
receiving the specific notification from the wireless communications network that the amount of bandwidth is available.

18. The machine-readable medium of claim 16, wherein the method further comprises:
receiving general notification of available bandwidth from the wireless communications network; and
determining if the available bandwidth is sufficient to transmit the data.

19. The machine-readable medium of claim 18, wherein the method further comprises:
monitoring a transmission rate for the data; and
terminating transmission of the data if the transmission rate is unacceptable.

20. A machine-readable medium having executable instructions to cause a processor in a computer to perform a method comprising:
receiving a request from a wireless device for specific notification when an amount of bandwidth becomes available in a wireless communications network; and
sending the specific notification to the wireless device when the amount of bandwidth becomes available.

21. The machine-readable medium of claim 20, wherein the method further comprises:
adding the request to a queue; and
searching the queue for a request for an amount of bandwidth that substantially matches the available bandwidth.

22. The machine-readable medium of claim 21, wherein the method further comprises:
sending general notification of available bandwidth to multiple wireless devices if all requests in the queue are for amounts of bandwidth greater than the available bandwidth.

23. The machine-readable medium of claim 22, wherein the general notification is sent on a pre-defined schedule.

24. The machine-readable medium of claim 22, wherein the general notification is sent when a data transmission exhausts the available bandwidth.

25. The machine-readable medium of claim 22, wherein the general notification is sent in conjunction with sending specific notification of a requested amount of bandwidth.

26. A machine-readable medium having executable instructions to cause a processor in a computer to perform a method comprising:
sending notifications of available bandwidth within a wireless communications network to multiple wireless devices.

27. A wireless device comprising:
a processing unit;
a memory coupled to the processing unit through a bus;
an interface coupled to the processing unit through the bus and further operable for coupling to a wireless communications network; and
a selective transmission process executed from the memory by the processing unit to cause the processing unit to determine an amount of bandwidth necessary to transmit data in the wireless communications network and to transmit the data through the interface when the amount of bandwidth is available.

28. The wireless device of claim 27, wherein the selective transmission process further causes the processing unit to send a request through the interface for specific notification when the amount of bandwidth becomes available and to receive the specific notification through the interface that the amount of bandwidth is available.

29. The wireless device of claim 27, wherein the selective transmission process further causes the processing unit to receive general notification of available bandwidth through the interface and to determine if the available bandwidth is sufficient to transmit the data.

30. The wireless device of claim 29, wherein the selective transmission process further causes the processing unit to monitor a transmission rate for the data and to terminate transmission of the data if the transmission rate is unacceptable.

31. A computerized system comprising:
a processing unit;
a memory coupled to the processing unit through a bus;
an interface coupled to the processing unit through the bus and further operable for coupling to a wireless communications network; and
a notification process executed from the memory by the processing unit to cause the processing unit to receiving a request through the interface for specific notification when an amount of bandwidth becomes available in the wireless communications network and to send the specific notification through the interface when the amount of bandwidth becomes available.

32. The computerized system of claim 31, wherein the notification process further causes the processing unit to add the request to a queue and to search the queue for a request for an amount of bandwidth that substantially matches the available bandwidth.

33. The computerized system of claim 32, wherein the notification process further causes the processing unit to send general notification of available bandwidth through the interface if all requests in the queue are for amounts of bandwidth greater than the available bandwidth.

34. The computerized system of claim 33, wherein the notification process further causes the processing unit to send the general notification on a predefined schedule.

35. The computerized system of claim 33, wherein the notification process further causes the processing unit to send the general notification when a data transmission exhausts the available bandwidth.

36. The computerized system of claim 33, wherein the notification process further causes the processing unit to send the general notification in conjunction with sending specific notification of a requested amount of bandwidth.

37. A wireless communications system comprising:
means for sending data through a wireless communications network based on available bandwidth in the network; and
means for sending notifications of the available bandwidth in the network.
